(19) United States
(12) Patent Application Publication
(10) Pub. No.: US 2026/0082360 A1
(43) Pub. Date: Mar. 19, 2026

(54) TARGET NUMBER ESTIMATION DEVICE, METHOD, AND STORAGE MEDIUM

(71) Applicant: KABUSHIKI KAISHA TOSHIBA, Tokyo (JP)

(72) Inventors: Tomoko ADACHI, Kawasaki Kanagawa (JP); Yuta HIRAI, Sagamihara Kanagawa (JP); Miyuki OGURA, Tachikawa Tokyo (JP)

(73) Assignee: KABUSHIKI KAISHA TOSHIBA, Tokyo (JP)

(21) Appl. No.: 19/285,441

(22) Filed: Jul. 30, 2025

(30) Foreign Application Priority Data
Sep. 17, 2024 (JP) 2024-160354

(51) Int. Cl. H04W 64/00; H04B 17/318; H04W 84/12; H04W 84/20

(52) U.S. Cl. CPC H04W 64/003; H04B 17/318; H04W 84/12; H04W 84/20

(57) ABSTRACT

According to one embodiment, a target number estimation device acquires first and second signals. The first signal includes information of a set of a first area and the number of targets of the first area. The second signal includes information of a set of a second area and the number of targets of the second area. The target number estimation device applies mathematical optimization processing on the number of targets of the first areas and the number of targets of the second areas to generate a third signal including information of a set of a third area and the number of targets of the third area. The first signal is generated based on first information of a first wireless system. The second signal is generated based on second information of the first wireless system.

### CROSS-REFERENCE TO RELATED APPLICATIONS

This application is based upon and claims the benefit of priority from Japanese Patent Application No. 2024-160354, filed Sep. 17, 2024, the entire contents of which are incorporated herein by reference.

### FIELD

Embodiments described herein relate generally to a target number estimation device, a method, and a storage medium.

There is a technique of estimating the number of targets (for example, the number of people) in each area by applying mathematical optimization processing on the number of targets counted within each sensor's measurement or observation range where a plurality of types of sensors are installed in a building.

Mathematical optimization is an approach of mathematically solving a solution of an optimization problem, and more specifically, is a method of obtaining a solution to minimize or maximize a specific objective function under given constraints by using a mathematical technique, property, or the like.

In the target number estimation technique, in a case where there are a plurality of sensor types, that is, in a case of a multi-sensor configuration, one or more sensors of each sensor type are installed in a certain target space. Each sensor observes the number of targets in an area defined as an observation range of each sensor. For all sensor types, information indicating the relationship between the area and the number of observation targets is input to the target number estimation device.

In the target number estimation, the number of observation targets in a portion overlapping with the area of each sensor of each sensor type with respect to an area in which the number of targets is intended to be estimated is given as a variable, and an equation indicating the relationship between the number of observation targets of each sensor and the variable is formulated. At this time, an error of each sensor is also given as a variable. By solving the simultaneous equations consisting of the number of equations corresponding to the number of all sensors to minimize the error variables, the target number estimation device can derive the number of estimation targets in the area where the number of targets is intended to be estimated without learning even in a case where sensor information is excessive or insufficient.

This target number estimation technique can improve the accuracy in the estimated number of targets in an intended estimation area using various types of sensor information.

However, in the conventional target number estimation technique using the mathematical optimization described above, even when there are a plurality of expected sensor types, that is, even when a multi-sensor configuration is assumed, only one type of sensor, for example, a wireless local area network (LAN) may be used as it may be the only existing sensor type in actual operation. When the number of observation targets input to the mathematical optimization processing is from one type of sensor, there is no advantage of applying mathematical optimization.

### BRIEF DESCRIPTION OF THE DRAWINGS

FIG. 1 is a diagram illustrating an example of an application of a target number estimation device according to an embodiment.

FIG. 2 is a diagram illustrating an example of a configuration of the target number estimation device according to the embodiment.

FIG. 3 is a diagram for describing a method (Method 1) of ascertaining a position of a STA of a wireless LAN, which can be applied in the target number estimation device according to the embodiment.

FIG. 4 is a diagram illustrating a mounting example of an AP of an AP MLD of a wireless LAN.

FIG. 5 is a diagram for describing a method (Method 2) of ascertaining the position of the STA of the wireless LAN, which can be applied in the target number estimation device according to the embodiment.

FIG. 6 is a diagram for describing a method (Method 3) of ascertaining the position of the STA of the wireless LAN, which can be applied in the target number estimation device according to the embodiment.

FIG. 7 is a diagram for describing a method (Method 4) of ascertaining the position of the STA of the wireless LAN, which can be applied in the target number estimation device according to the embodiment.

FIG. 8 is a diagram for describing a method (Method 5) of ascertaining the position of the STA of the wireless LAN, which can be applied in the target number estimation device according to the embodiment.

FIG. 9 is a diagram schematically illustrating that the target number estimation device according to the embodiment improves estimation accuracy of the number of targets by mathematical optimization.

FIG. 10 is a flowchart illustrating a processing procedure of the target number estimation device according to the embodiment.

### DETAILED DESCRIPTION

In general, according to one embodiment, a target number estimation device includes a data acquisition unit and a target number estimation unit. The data acquisition unit acquires a first signal and a second signal. The first signal includes information regarding a set of a first area obtained by dividing a predetermined geographical area and the number of targets corresponding to the first area, by the number of first areas. The second signal includes information regarding a set of a second area obtained by dividing the predetermined geographical area and the number of targets corresponding to the second area, by the number of the second areas. The target number estimation unit applies mathematical optimization processing on the number of targets for each of the first areas included in the first signal and the number of targets for each of the second areas included in the second signal to generate a third signal including information regarding a set of a third area obtained by dividing the predetermined geographical area and the number of targets corresponding to the third area, by the number of the third areas. Both the first signal and the second signal are signals generated based on a same first wireless system. The first signal is based on first information of the first wireless system. The second signal is based on second information of the first wireless system.

Hereinafter, embodiments will be described with reference to the drawings.

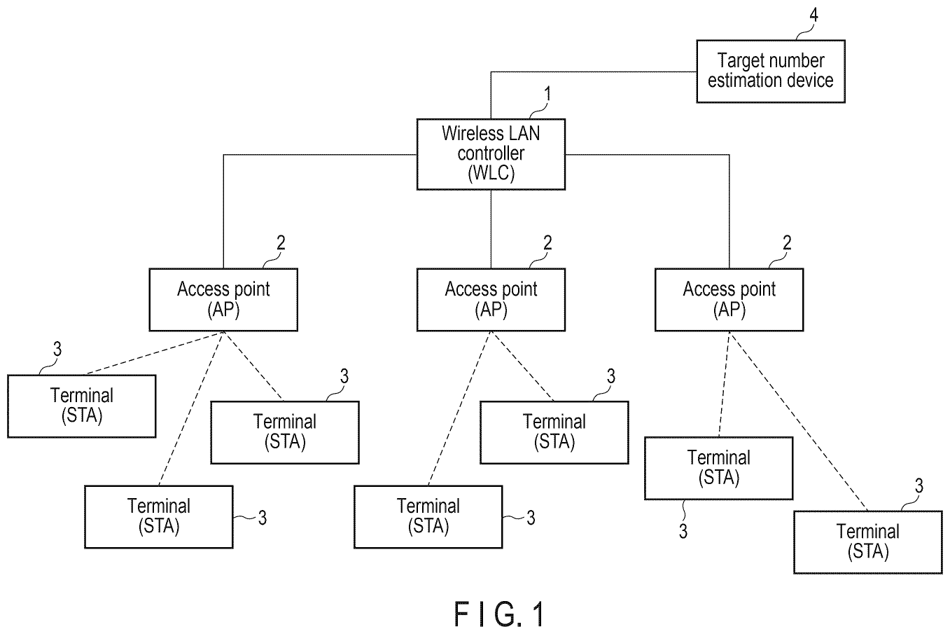

FIG. 1 is a diagram illustrating an application example of a target number estimation device 4 according to an embodiment.

The target number estimation device 4 is a device that can derive the number of observation targets from different viewpoints as if there were a plurality of sensor types while there is only a single sensor type, and obtain the number of targets in a target area by mathematical optimization.

The number of targets may be the number of specific devices or the like in addition to the number of people (the number of people in a certain area is also expressed as the number of people present). In the present embodiment, the description will proceed by using the number of people present.

In addition, in the present embodiment, a wireless sensor is exemplified as a single sensor type. Among wireless sensors, in particular, a wireless LAN will be described, but a sensor using other wireless communication such as Bluetooth (registered trademark) (including Bluetooth Low Energy) or cellular communication may be used. FIG. 1 illustrates an example in which a wireless LAN is used.

Here, the wireless LAN uses, for example, IEEE802.11 standards (including extended standards such as 11a/b/g/n/ac/ax/be), or Wi-Fi certification (including Wi-Fi CERTIFIED 4/5/6/7) is acquired from the Wi-Fi Alliance. In the IEEE802.11 standard, a station (STA) is usually used in a concept including an access point (AP). A STA excluding an AP is expressed as a non-AP STA. In the present embodiment, a concept excluding an AP is used unless otherwise noted. The STA is also referred to as a client.

As illustrated in FIG. 1, the target number estimation device 4 is connected to a wireless LAN controller (WLC) 1. The WLC 1 is a device that integrally controls a plurality of access points (APs) 2. The WLC 1 collects various types of data from each of the plurality of APs 2 and provides the collected data to the target number estimation device 4. In other words, the target number estimation device 4 acquires data related to target number estimation of a plurality of APs 2 via the WLC 1.

The AP 2 is a device that performs wireless communication to accommodate a plurality of terminals (STA) 3 existing within a certain range in a wireless LAN. The plurality of APs 2 are arranged to be scattered in a predetermined geographical area such as an office building. That is, a wireless service area is formed in the predetermined geographical area by the plurality of APs 2. The plurality of APs 2 are basically in a fixed arrangement.

The STA 3 is a device such as a personal computer (PC) or a smartphone used in a predetermined geographical area such as the office building described above. The STA 3 has a wireless communication function, and can connect to the Internet or the like by performing wireless communication with the AP 2.

The target number estimation device 4 acquires data from a plurality of APs 2 via the WLC 1, and estimates the number of STAs 3 (people who use the STAs 3) using the data.

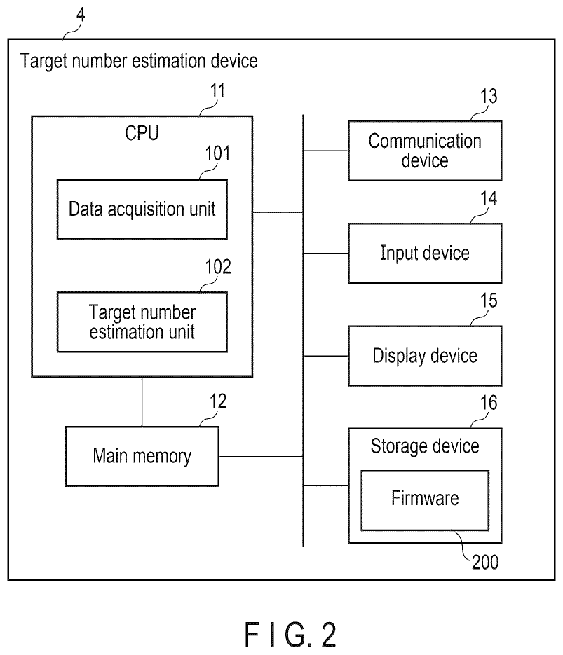

FIG. 2 is a diagram illustrating a configuration example of the target number estimation device 4.

The target number estimation device 4 includes a central processing unit (CPU) 11, a main memory 12, a communication device 13, an input device 14, a display device 15, and a storage device 16.

The CPU 11 is a processor that loads firmware (program) 200 stored in the storage device 16 into the main memory 12 and executes the firmware. By executing the firmware 200, the CPU 11 can operate as a data acquisition unit 101 and can operate as a target number estimation unit 102. The data acquisition unit 101 performs processing of acquiring data related to target number estimation. The target number estimation unit 102 performs processing of estimating the number of people present in a predetermined geographical area by using the data acquired by the data acquisition unit 101. Mathematical optimization is used for the estimation processing. The data acquisition unit 101 and the target number estimation unit 102 may be implemented as hardware such as an electric circuit, for example.

The main memory 12 is a volatile storage device such as a dynamic random access memory (DRAM). The main memory 12 stores programs and data as a work area of the CPU 11.

The communication device 13 is a device that performs wired communication or wireless communication with the WLC 1. The input device 14 is a device that handles an input side of a user interface such as a keyboard or a pointing device. The display device 15 is a device that handles an output side of a user interface such as a liquid crystal display (LCD). For example, a target number estimation result is displayed on the display device 15. In addition to being displayed, the target number estimation result can be output as data to another device, a storage, a cloud, or the like.

The storage device 16 is a nonvolatile storage device such as a hard disk drive (HDD) or a solid state drive (SSD). As described above, the storage device 16 stores the firmware 200 executed by the CPU 11. Data of the target number estimation result may be stored in the storage device 16.

As a method of detecting the presence/absence of a person using the wireless LAN, for example, in a case where work is performed by connecting a notebook PC to the wireless LAN in an office or the like, a method of detecting the notebook PC can be used. Assuming that the position of the notebook PC indicates an approximate position of a person, the position of the notebook PC can be used to ascertain the number of people present in a certain area.

In this case, the notebook PC is connected to the AP 2 of the wireless LAN as the STA 3 of the wireless LAN. In order to perform wireless communication between the AP 2 and the STA 3, the position of the STA (note PC) 3, that is, the position of the person can be derived by receiving a wireless signal transmitted from the STA 3 by the AP 2 or the like connected thereto or by the STA 3 receiving a wireless signal transmitted from the AP 2.

Alternatively, even before connection is established with the AP 2, the STA 3 may transmit a wireless signal, and the position of the STA (note PC) 3, that is, the position of the person can be derived by using the transmitted wireless signal.

For example, there are a method of using received signal strength indicator (RSSI) of a wireless signal, a method of using a difference between a transmission time (Time of Departure: TOD) and a reception time (Time of Arrival: TOA) of a wireless signal, and the like. The former uses a property that a wireless signal attenuates in accordance with a propagation distance (the attenuation amount varies depending on a transmission path environment), and the latter uses a time required for the wireless signal to propagate in a space. Instead of the RSSI, signal-to-noise ratio (SNR) or the like may be used. When the propagation time is obtained from the difference between the ToD and the ToA, in the wireless LAN, a method is mainly used in which a STA 3 (including an AP 2 in this case) on a side where the time difference is intended to be obtained transmits a management frame or the like, and a STA 3 (including an AP 2 in this case) as a reception destination of this frame receives a response frame (Acknowledgement (Ack) frame in IEEE 802.11 wireless LAN) which is a control frame transmitted after a fixed time of the frame reception, thereby measuring a round trip time (RTT) obtained by adding an occupancy time of each frame on a space related to the frame length, a fixed time before the transmission of the control frame, and twice a time required for propagation in the space (because there is a round-trip frame exchange). By multiplying the light speed by the propagation time, the propagation distance is obtained.

There is also a method of detecting a position of a person, not the STA (notebook PC) 3, by using a wireless LAN. The wireless LAN signal is used for sensing, and the wireless LAN signal is transmitted and received between the AP 2 and the (other) AP 2, between the AP 2 and the STA 3, or the like, and a transmission path state, that is, channel state information (CSI) is acquired on the reception side, whereby presence/absence of a person on the transmission path can be ascertained.

As means for ascertaining the position of the STA (person) 3, for example, there are the following plurality of methods. The target number estimation device 4 (target number estimation unit 102) can separately input these to the mathematical optimization processing. That is, the input can be handled as if the input to the mathematical optimization processing by a different sensor type. Although not a single method but a plurality of methods may be presented in each method, these methods may be input to the mathematical optimization processing as different methods. Some methods may be merged and used as an input to the mathematical optimization processing. The method of ascertaining the positions of a plurality of STAs (people) 3 is performed at a certain constant cycle, and the input to the mathematical optimization processing is simultaneously performed. The input to the mathematical optimization processing is time-series data. In each ascertaining method, data may be generated by observing a certain period (a period equal to the cycle in maximum) within a certain cycle and performing statistical processing. For example, if the same STA 3 is observed in a certain period, the count of the STA 3 is handled as 1 (overlapping count is not performed).

Information of the STA 3 that is connected and the observation information of the wireless signal (the wireless signal can be received even if the STA 3 is not connected) received from each STA 3, which are acquired by each AP 2, are collected by the WLC 1. The observation information of the wireless signal received from each STA 3 includes the MAC address of the STA 3 as the transmission source of the wireless signal, the IP address allocated in the IP layer, the user information used for authentication at the time of connection of the wireless LAN, the RSSI of the wireless signal from the STA 3 (the RSSI is allowed to be represented by time average by smoothing by implementation), the SNR (noise power at the time of calculating the SNR can be a case using average power in a state where transmission and reception are not performed when there is no channel reservation, that is, NAV (Network Allocation Vector: indicates a mechanism for performing virtual carrier sensing in the IEEE802.11 wireless LAN or an activated period thereof. Here, the latter meaning is used) is not set, or can be a case using a fixed value), and the target number estimation device 4 (data acquisition unit 101) can acquire these pieces of information via the WLC 1.

(Method 1: Counting STA in Area of AP to which STA is Connected)

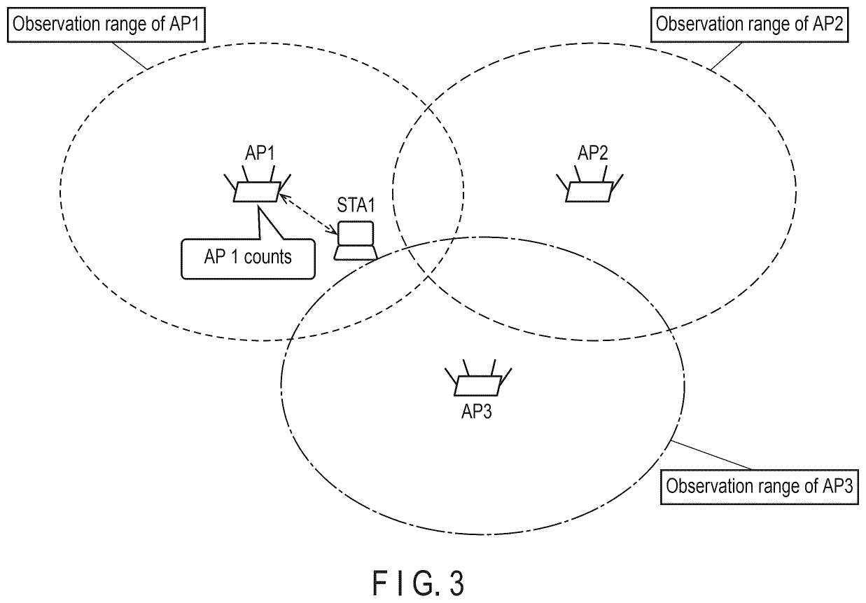

As illustrated in FIG. 3, a plurality of APs (AP1 to AP3) are in a target space. An observation range of each AP is defined. It is desirable to define the observation range of each AP in consideration of an environment in which each AP is disposed as the observation range is influenced by the output power of each AP and the propagation of the wireless signal. A plurality of sets of the number of people present with respect to the observation range of each AP are input to the mathematical optimization processing.

The output power may be, for example, maximum output power or output power in a case where a beacon frame is transmitted. When the propagation environment of the wireless signal is similar, since the wireless signal of the AP having larger output power reaches farther than that of the AP having smaller output power, it is desirable that the observation range of the AP having the larger output power be wider than the observation range of the AP having the smaller output power.

The beacon frame is a management frame scheduled to be periodically transmitted from the AP, and broadcasts capability information such as optional functions that the AP supports in addition to synchronization information and a service set identifier (SSID). The STA confirms the presence of the AP by the beacon frame or the like from the AP, and in a case where a plurality of APs are confirmed, for example, the STA connects to the AP whose frame (beacon frame or the like) was received with the highest RSSI among the plurality of APs. Here, the “connected” state is a state in which the STA can transmit and receive a data frame to and from the AP, and is a state after completion of an authentication process, an association process, and, if necessary, security setting, as a connection process.

The wireless signal is basically attenuated by a distance between a transmitter and a receiver. In a case where the transmitter and the receiver are in a line of sight environment (LOS), attenuation occurs in a square law with respect to the distance. In a non-line of sight (NLOS) environment, attenuation occurs in an N-th power law (N>2) with respect to the distance between the transmitter and the receiver, and a propagation loss coefficient N depends on the propagation environment. For example, in a case where the wireless signal reaches the reception side by being reflected by such as a ceiling, a floor, and a wall, the propagation loss coefficient N changes depending on the multipath. In a case where there is a wall or the like between the transmitter and the receiver and a wireless signal is transmitted through the wall or the like, transmittance changes depending on the wall material, the frequency, and the incident angle, and the wireless signal is attenuated. Therefore, in a case where the output power of the APs is the same, it is desirable to widen the observation range of the AP having larger surrounding line-of-sight environment.

In Method 1, in a case where one STA is connected to an AP, the number of people present is counted as one in the observation range of the AP. In FIG. 3, since a STA1 is connected to an AP1, the number of people present is counted as one person as the observation range of the AP1. In a case where the number of people present is already counted as the observation range of the AP1, 1 is added for the STA1. In FIG. 3, since the STA1 does not connect to an AP2 nor an AP3, the number of people corresponding to the STA1 is not counted in the observation ranges of the AP2 and the AP3.

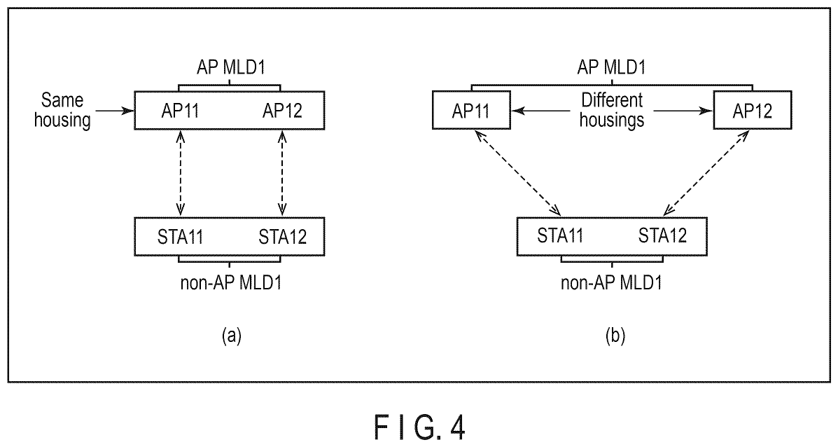

Normally, the STA connects to only one AP at a maximum. In IEEE802.11be, there is a function called multi-link operation (MLO), and in a case of supporting this function, a plurality of STAs or a plurality of APs are configured in one enclosure. A device having a plurality of STAs is referred to as a non-AP MLD (Multi-Link Device), a device having a plurality of APs is referred to as an AP MLD, and the non-AP MLD and the AP MLD can be connected to each other. In this case, a certain AP under the AP MLD and a certain STA under the non-AP MLD perform one-to-one communication on a certain frequency link (frequency channel) (for example: FIG. 4(a)). The frequency links having such a configuration can be held at different frequencies up to the number of pairs that can be configured by the APs and the STAs, and can be used for communication. Each AP of the AP MLD and each STA of the non-AP MLD has a unique medium access control (MAC) address, and each of the AP MLD and each of the non-AP MLD has a MAC address (referred to as an MLD MAC address). In the case of such a connection form, the observation range of the AP may be replaced with the observation range of the AP MLD, and the count corresponding to the STA may be replaced with the count corresponding to a unit of the non-AP MLD.

It is also conceivable that the wireless LAN is extended to a form in which APs of the AP MLD are not necessarily in the same enclosure (example: FIG. 4(b)). When an AP MLD having such an AP is referred to as a non-co-located AP MLD, the above-described AP MLD in which all APs are in the same enclosure is a co-located AP MLD. In the case of the non-co-located AP MLD, one or a plurality of APs in the same enclosure, that is, in the same location is treated as one virtual AP, and the observation range of each virtual AP is defined. As a case where the STA MLD is connected to the non-co-located AP MLD, in a case where one or a plurality of STAs under the STA MLD are connected to one or a plurality of APs at the same location under the non-co-located AP MLD, the number of people present in the observation range of the virtual AP including the APs at the same location may be counted for one person. On the other hand, in a case where a STA11 under a STA MLD1 is connected to an AP11 under a non-co-located AP MLD1, a STA12 under the STA MLD1 is connected to an AP12 under the non-co-located AP MLD1, and the AP11 and the AP12 are installed away from each other without being in the same enclosure, the count for the person according to the STAs should be divided in the observation range of each virtual AP. For example, each of the virtual observation range (in a case where there are other APs in the same location as the AP11 under the non-co-located AP MLD1, including these APs) of the AP11 and the virtual observation range (in a case where there are other APs in the same location as the AP12 under the non-co-located AP MLD1, including these APs) of the AP12 counts ½ person. This is a method in which one person is divided by the number of target virtual APs and the divided number is allocated to the observation range of each virtual AP. For example, in a case where the width of the frequency channel or the traffic capacity allocated to the frequency link is different, or the like, the number of people may be proportionally counted in accordance with the ratio of the channel width or the ratio of the traffic capacity.

(Method 2: Number of Surrounding STAs Observed in Each AP (Regardless of Connected or not)

In Method 1, the method of counting the number of people present in the observation range of the AP for one person in a case where the STA is connected to the AP has been described, and the counting method in the case of the AP MLD has been described. In Method 2, regardless of whether the STA is connected to the AP, the STA observed by each AP is counted as it is in the observation range of the AP.

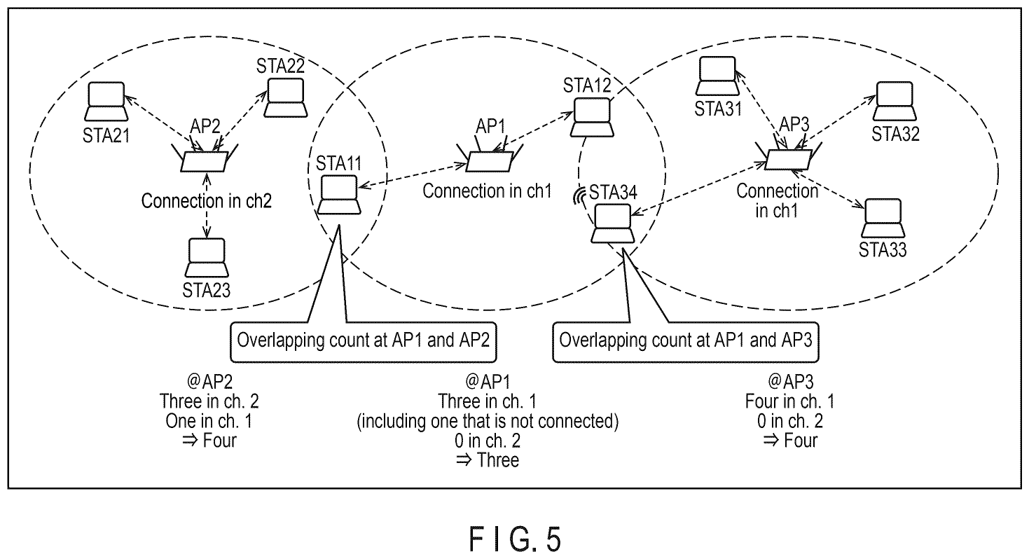

In FIG. 5, the AP1 and the AP3 perform an operation of connection to the STA in a frequency channel ch1, and the AP2 performs an operation of connection to the STA in a frequency channel ch2.

In other words, the operation of connection to the STA in a certain frequency channel means that Basic Service Set (BSS) is configured in the frequency channel in the IEEE802.11 wireless LAN. In the BSS, all the STAs (including APs) constituting the BSS are synchronized. The BSS configured by the AP is referred to as an infrastructure BSS, and may be distinguished from an independent BSS configured only by STAs without an AP.

In FIG. 5, the AP1 is connected to two STAs, the AP2 is connected to three STAs, and the AP3 is connected to four STAs. In Method 2, each AP observes the wireless signal from the STA even if the STA is not connected, and ascertains the STA as the transmission source. To ascertain a STA as the transmission source means to receive a wireless signal by an antenna, perform a decoding process on a physical packet acquired by converting the wireless signal into a baseband signal, extract a MAC frame, and save a MAC address described in a transmission source address (TA) of the MAC frame as an observed STA. The overlapping count can be avoided by ascertaining the observed STA. Each AP also observes other frequency channels (channels other than an operation channel are also referred to as off-channels). As a result, the AP1 observes one STA connected to the AP3 (assuming a situation where the STA connected to the AP2 cannot be observed even if ch2 is observed) in addition to the two STAs connected to its own AP in the operating channel ch1, and observes a total of three STAs (people). The AP2 observes one STA connected to the AP1 by observing ch1 in the operation channel ch2 in addition to the three STAs connected to AP itself, and observes a total of four STAs (people). The AP3 observes four STAs connected to the AP itself in the operation channel ch1 (assuming a situation where the STA connected to the AP2 cannot be observed even if ch2 is observed), and observes a total of four STAs (people) including other channels. As a result, in Method 2, three people are input to the mathematical optimization processing in the observation range of the AP1, four people are input to the mathematical optimization processing in the observation range of the AP2, and four people are input to the mathematical optimization processing in the observation range of the AP3. In the case of Method 1 described above, two people are input in the observation range of the AP1, three people are input in the observation range of the AP2, and four people are input in the observation range of the AP3.

In a case where STAs are observed in different frequency channels, it is desirable that the observation range of each AP in Method 2 be set in consideration of propagation in each of the plurality of frequency channels. The attenuation of a wireless signal that is a radio wave depends on the frequency. In LOS, the reception power is ¼ times when the frequency is doubled, and conversely, the reception power is 4 times when the frequency is ½. Therefore, in general, a lower frequency band has a characteristic that propagation attenuation of a wireless signal is smaller and the wireless signal is transmitted to a farther distance. The frequency bands used as the wireless LAN include a 2.4 GHz band, a 5 GHz band, and a 6 GHz band. For example, in a case where Method 2 is limited to observation in the 2.4 GHz band, it is desirable to define a wider AP observation range than that in a case where observation is limited in the 5 GHz band or the 6 GHz band. In a case where the observation is performed by using all of the 2.4 GHZ band, the 5 GHz band, and the 6 GHz band, the observation range of the AP may be defined in consideration of propagation in a wider 2.4 GHz band, or the observation range of the AP may be defined in consideration of the specific gravity for each frequency band in which the STA is frequently observed.

A method of deriving the number of people present on the AP side from different viewpoints by using RSSI at the time of receiving a wireless signal transmitted by the STA will be described below.

In the following description, RSSI will be described, but SNR may be used instead of RSSI. For the case when SNR is used, it will be handled as an input to the mathematical optimization processing by another method, that is, as if by another sensor type. In a case where the RSSI is replaced with the SNR, larger or smaller of the RSSI may be replaced with larger or smaller of the SNR, or whether the value is greater or less than the RSSI may be replaced with whether the value is greater or less than the SNR. The information is not limited to the information acquired via the wireless LAN controller, and the propagation time or the like of the wireless signal may be used as described above. In this case, it will be handled as an input to the mathematical optimization processing by another method, that is, as if by another sensor type, as well. In a case where the RSSI is replaced with the propagation time of the wireless signal, the RSSI tends to be larger and the propagation time tends to be shorter when the distance between the AP and the STA is shorter. Therefore, larger or smaller of the RSSI may be replaced with shorter or longer of the propagation time, or whether the value is greater or less than the RSSI may be replaced with whether the value is less or greater than the propagation time.

### (Method 3: Number of Connections at Each AP×RSSI)

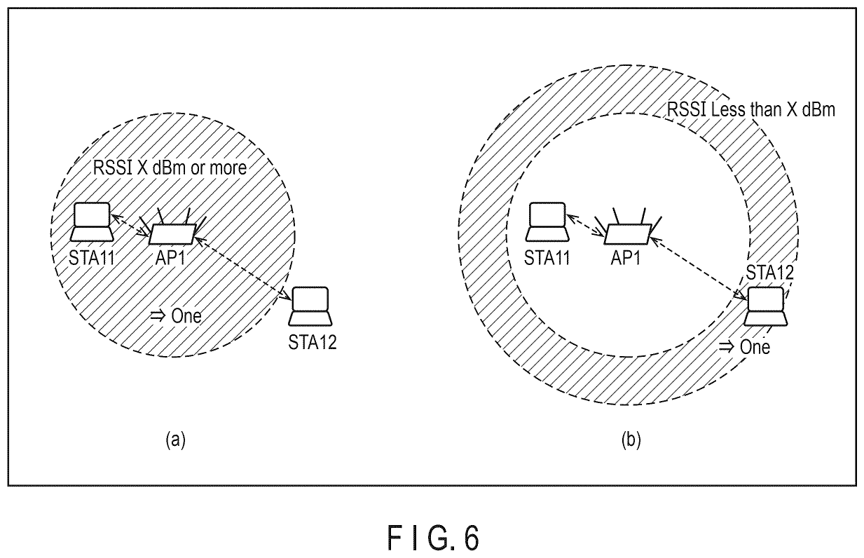

Although Method 3 is similar to Method 1, as illustrated in FIG. 6(a), when the connected STA is counted, a threshold value is provided for the RSSI of the wireless signal received from the STA, and only the STA having the RSSI greater than or equal to the threshold value is counted. The wireless signal from the STA is desirably not subjected to transmission power control. For example, the AP may observe a wireless signal for transmitting a Probe Request frame or the like which is a management frame, or a wireless signal for transmitting a different management frame which the STA was made by the AP to transmit for observation, and determine whether to count the STA or not in accordance with the RSSI. In FIG. 6(a), the threshold value is indicated as X dBm and it is described that the STA is counted when its wireless signal is greater than or equal to X dBm, but in practice, a certain unique value is provided as the threshold. Originally, it is desirable to provide the threshold value of the RSSI for each STA in accordance with the transmission power of the STA, but there is a case where the transmission power of the STA cannot be ascertained, and the threshold value may be temporarily set to one value. In a case where the device type of the STA can be ascertained, the threshold value of the RSSI may be set in accordance with the device type. For example, in the case of a PC, the transmission power tends to be larger, whereas in the case of a smartphone or the like, the transmission power tends to be smaller. Therefore, the threshold value is set in consideration of such tendency. In FIG. 6(a), since there is one STA whose wireless signal is received with an RSSI greater than or equal to the threshold value being set, while the number of STAs is counted as two in Method 1, it is counted as one here. It is appropriate to set the observation range of the AP to be smaller than that in Method 1.

Method 3 may be input to the mathematical optimization processing together with Method 1 as if Method 3 is handled as a sensor type different from Method 1.

In addition to Method 2, Method 3 may be input to the mathematical optimization processing as if Method 3 is handled as a sensor type different from Method 2.

In contrast to FIG. 6(a) described above, as illustrated in FIG. 6(b), a method of performing counting the STA when the RSSI is less than the threshold value may be used. This method may be handled as a method different from that of FIG. 6(a). In a case where the method as illustrated in FIG. 6(b) is adopted, it is appropriate to define an observation range with an open center as the observation range of the AP.

The above description is processing on the wireless signal received from the STA. But even for a contrary case, when the STA observes the wireless signal received from the AP, by the STA notifying the AP whether or not the RSSI exceeded the threshold value (in this case, the AP counts the STA only in the case of the notification that the RSSI exceeds the threshold value when the operation similar to that in FIG. 6(a) is expected, and counts the STA only in the case of the notification that the RSSI is less than the threshold value when the operation similar to that in FIG. 6(b) is expected. The AP needs to notify the connected STA of the threshold value in advance. In a case where it is possible to select either the value greater than or equal to the threshold value or the value less than the threshold value, it is necessary to notify the connected STA of the instruction which to take in advance), or alternatively, by the STA notifying the AP of the RSSI of the wireless signal received from the AP (in this case, the AP determines whether to count the STA or not in consideration of the threshold value of the RSSI), even though the wireless signal to be observed is not an uplink from the STA to the AP but a downlink from the AP to the STA, the wireless signal can be similarly observed on the AP side. The AP may directly transfer the information from the STA to the wireless LAN controller, and the wireless LAN controller or the target number estimation device via the wireless LAN controller may finally determine the count from the threshold value and the RSSI information. Here, the wireless signal from the AP observed by the STA is also desirably not subjected to transmission power control. For example, the STA may observe a wireless signal for transmitting a Beacon frame or the like, which is a management frame from the AP, and may notify the AP according to the RSSI. In a case where the wireless signal from the AP is observed by the STA, the threshold value used for the same AP is naturally common among a plurality of STAs. In a wireless LAN network (Extended Service Set (ESS) in IEEE802.11 wireless LAN) including a plurality of APs, for example, when transmission power is commonly set for at least a Beacon frame or a frame to be set as a main observation target by a STA in a plurality of APs, a common value can be used as the threshold value of wireless signals from the APs.

A method of determining whether or not to count STAs by providing the threshold value to the RSSI of the wireless signal from the STA as described above may be incorporated into the method of counting the number of STAs observed by the AP regardless of whether or not the STA is connected to the AP in Method 2.

(Method 4: Recombination of Count in AP by Taking RSSI into Account)

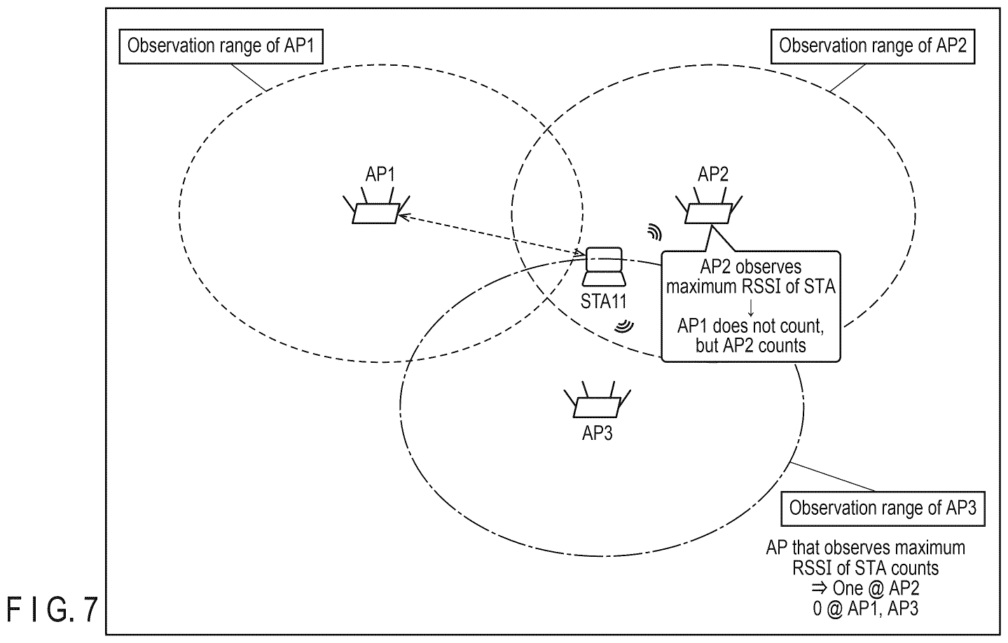

In Method 4, regardless of whether or not a STA is connected, in a case where the STA is observed by a plurality of APs, the AP that has received the wireless signal from the STA at the maximum power counts the STA. FIG. 7 illustrates a case where the STA11 is connected to the AP1 but the wireless signal (for example, as described above, a wireless signal for transmitting a Probe Request frame or the like which is a management frame, or a wireless signal for transmitting another management frame to be transmitted from the AP to the STA for observation) from the STA11 is also observed by the AP2 and the AP3 in addition to the AP1, and the wireless signal from the STA11 observed by the AP2 is larger than that by the AP1 and the AP3, that is, the wireless signal from the STA11 observed by the AP2 has the maximum RSSI. In this case, the STA11 is counted by the AP2 (while by such as Method 1, the STA11 is counted by the AP1). Therefore, in a situation like FIG. 7 where there is only one STA, the AP2 counts the STA11, and the AP1 and the AP3 do not count the STA11.

When a plurality of APs observe a STA through channels including their off-channels (a channel that performs communication with the connected STA is referred to as an on-channel, and a channel other than the on-channel is referred to as an off-channel), the observation period becomes long, and in practice, while a certain AP observes a state after the STA moves, observation information of the STA in another AP to be compared with the certain AP may not be appropriate because of the observation being made before the STA moved. Thus, for example, in a case where the RSSI when a certain AP observes the STA greatly varies, it can be determined that the STA moved, and it is desirable to assume that the movement is completed at the time when the RSSI variation is settled, and to compare the RSSI with the observed RSSI of the STA in another AP only after the movement completion time (in this case, it can be handled as being able to be observed almost simultaneously). Alternatively, in a case where the observation time at the AP of the STA has elapsed for a certain time or more (handled as old observation information), the observation information may not be used.

In a case where the wireless signal from the STA can be observed only by a certain AP and cannot be observed and compared by a plurality of APs (as described above, including a case where the movement of the STA is estimated and the observation information of the STA is not used and a case where the observation information of the STA is not used for setting an effective observation period or the like), the wireless signal is counted by the AP that has observed the wireless signal. Even if the wireless signal from the STA is not observed, the count in the last counted AP may be maintained for a certain period, but there is a case where the STA is actually absent. Thus, it is desirable to limit the certain period to an average time or the like in which it can be expected that the STA can be observed by a plurality of APs.

Also in Method 4, as in Method 3, a method of providing a threshold value to the RSSI used in each AP and limiting the RSSI may be incorporated.

In the above description, the case where the AP side observes the RSSI of the wireless signal of the STA has been described. On the other hand, the STA side may observe the RSSI of the wireless signals from a plurality of APs, and counting may be performed in the observation range of the AP having the maximum RSSI among the plurality of APs. Similarly to the method described in Method 3, the STA may notify the AP of the RSSI of the wireless signals from the plurality of APs and the STA can be counted at the AP of the maximum RSSI via the wireless LAN controller, or the STA itself may determine the AP having the maximum RSSI and notify the AP of its determination, and the AP or the wireless LAN controller may cause the wireless LAN controller or may finally cause the target number estimation device via the wireless LAN controller to count the STA at this AP.

Unlike Method 1 and Method 3, in Method 4, the definition of the observation range of the AP does not matter whether or not the STA is connected to the AP, and thus it is appropriate to narrow the definition of the observation range of the AP more than the definition of the observation range of the AP in Method 1 or Method 3. In general, when a STA is connected to a certain AP, even if another AP is more suitable for wireless connection (for example, the reception strength of the wireless signal from another AP is higher than the reception strength of the wireless signal from the connected AP), there is a problem that the STA continues to maintain connection with an old AP without switching to an AP having better condition (this is referred to as a sticky terminal problem or the like). In Method 1 and Method 3, it is desirable to define the observation range of the AP widely in consideration of this sticky terminal problem. On the other hand, in Method 4, since the AP that performs observation with the maximum RSSI counts the STA, if the STA can be observed by a sufficient number of APs almost simultaneously, there is no influence of the sticky terminal problem.

(Method 5: Trilateration by RSSI from Plurality of APs)

Method 5 is similar to Method 4 in the sense that the STA is observed by a plurality of APs, but in each AP, a distance between the STA and the AP is estimated from the RSSI of a wireless signal from the STA, and the STA is estimated to be located at an intersection of the estimated distances from each AP. When there is a difference in height between the APs and the STA, three APs are required because the position estimation of the STA has three-dimensional parameters of length, width, and height. This is position estimation using a trilateration mechanism. Instead of observing the RSSI of the wireless signal from the STA by the plurality of APs, the STA may receive the RSSI of the wireless signal from the plurality of APs, estimate the distance to each AP, and estimate the position of the STA. In any case, for example, by collecting the acquired RSSI by the wireless LAN controller, the position of the STA can be estimated from the collected RSSI information and the position of the AP.

The distance between each AP and the STA is derived from a site-general propagation model provided in, for example, ITU-R P. 1238-12. The propagation loss coefficient N may be estimated and used in advance by propagation measurement in the target area. The reception power Pr [dBm] is represented by Pr=Pt+Gr+Gt−L. Here, Pt is the transmission power [dBm], Gt and Gr are the antenna gain [dBi] of a transmitter and a receiver, and L is the propagation loss [dB]. While the RSSI is a relative index, the reception power is an absolute value and thus cannot be handled as the same value. However, focusing on L that depends on the distance d, in an area where the RSSI value is not saturated, the relationship of RSSI=A−10N log 10(d) is formulated (A is a constant). By appropriately setting A and N, the distance can be estimated from the RSSI.

In a case where the distance is actually estimated and the position of the STA is estimated by trilateration, the RSSI varies with time due to attenuation of radio waves by multipath, noise factors, or the like. Therefore, a method such as a Kalman filter may be used to reduce the influence. Due to the characteristics of propagation in which the propagation loss increases with the logarithm of the distance, the closer the distance, the higher the estimation accuracy of the distance, and conversely, the farther the distance, the lower the estimation accuracy. Therefore, there is a method of improving the position estimation accuracy by, for example, applying a weight to the estimated distance. These existing accuracy improvement methods may be used.

The distance of the STA from each AP may be estimated from the RSSI of the wireless signal of the STA with reference to the reception strength of the wireless signal between the APs and the actual distance between the APs. However, in this case, it is necessary to consider that LOS is not necessarily guaranteed between the AP and the STA while propagation between the APs has LOS due to ceiling installation or the like, for example, and on the other hand, it is necessary to consider the antenna gain in the horizontal direction in each AP in the observation of the wireless signal between the APs. A method of determining a measurement point within a specific space (that is, the location of the measurement point is known), measuring the RSSI of wireless signals from the APs at each measurement point (for example, wireless signals that transmit a Beacon frame. The same applies hereinafter), creating a map of the RSSI in the specific space, comparing the RSSI of the wireless signal from each AP at the terminal intended to be measured with the map of the RSSI, and estimating that the terminal is located at a position close to the characteristic, that is, performing pattern matching of the map of the RSSI and the RSSI at the terminal to be measured, and estimating the position of the terminal can be referred to as fingerprint or fingerprinting. Since the location of the AP is known and the relative positional relationship between the APs is clear, it can be said that the method of referring to the reception strength of the wireless signal between the APs and the actual distance between the APs utilizes fingerprint.

In Method 5, an area for counting STAs is different from that in the previous methods. Instead of counting the STA in the observation range of each AP as in the above-described methods, it is as though sensors that detect the STA having each observation range are disposed in a measurement range, and the STA is counted at one of the virtual sensors' observation range which covers the estimated position of the STA. For example, the observation range may be equally divided in units of blocks of a certain size, and the STA may be counted at the block which covers the estimated position of the STA. Alternatively, the STA may be counted in a certain block and its neighboring blocks in consideration of the deviation of the estimated position of the STA. In this case, a value obtained by dividing 1 by the total number of a certain block and its neighboring blocks is set as a count of each corresponding block. Alternatively, the same range as each area representing the number of people present at the output (that is, the output after applying the mathematical optimization) from an existing people number estimation device is set as each observation range of a pseudo sensor, and the STA is counted at the observation range which covers the estimated position of the STA.

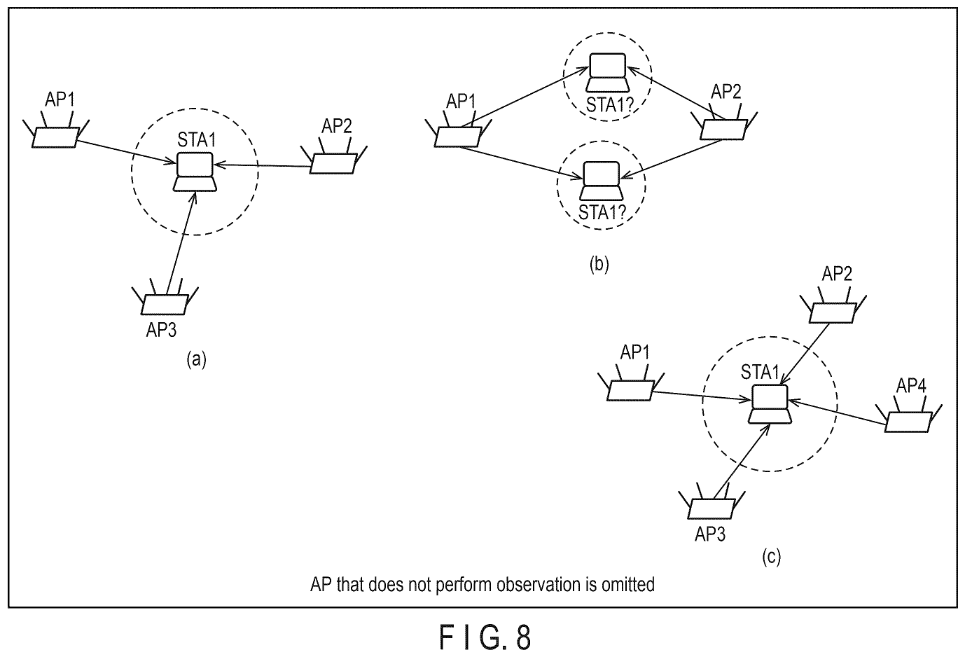

FIG. 8(a) illustrates an example in which the positions of STA1 are estimated by three APs, specifically, the AP1, the AP2, and the AP3. The STA may be counted in an area having a certain size as described above in consideration of uncertainty in the estimated position of the STA. For example, as illustrated in FIG. 8(b), in a case where the distance to the STA1 can be estimated only by two APs, the AP1 and the AP2, it is conceivable that the estimated position cannot be narrowed down to a certain fixed area and can be narrowed down only to a high possibility that the STA exists in either of the two areas. In this case, for example, the count 1 of the STA is equally divided between these two areas. That is, since there are two areas, ½ is counted in each area. If each area is divided into finer blocks, the count 1 is further equally divided by the number of blocks within each area. As illustrated in FIG. 8(c), in a case where the distance to the STA can be estimated with more than three APs, it may be conceivable that a contradiction occurs due to the influence of the propagation environment or the like between the distances estimated using the RSSI or the like from each AP, and the area estimated to have a possibility that the STA exists becomes wider without being narrowed down. In such a case, the number of blocks to be counted is increased, and the count 1 of the STA is equally divided and counted by those blocks. In any of the examples in FIGS. 8(a) to 8(c), APs whose distances to the STA are not estimated are omitted. In some cases, the omitted AP does not observe the wireless signal from the STA in the first place, or the time from the observation has elapsed excessively, or the RSSI of the observed wireless signal is equal to or less than a certain threshold value (can be referred to as a method obtained by combining the case illustrated in FIG. 6(a), which is one of the implementation examples of Method 3).

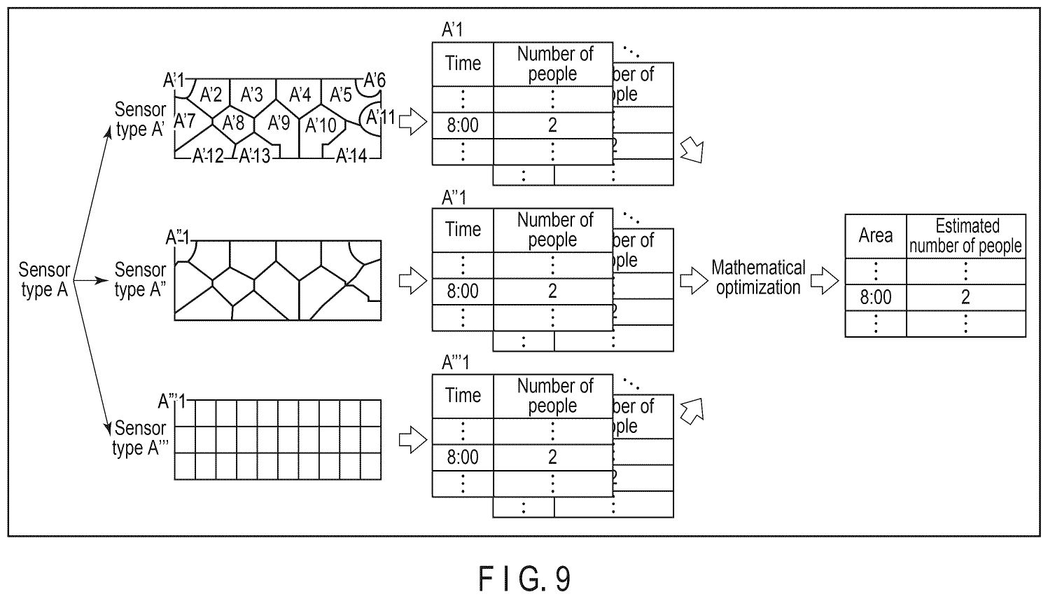

The target number estimation device 4 (target number estimation unit 102) inputs two or more results obtained by deriving the number of people present from different viewpoints as in Methods 1 to 5 to the mathematical optimization processing, and obtains the number of people present in the target area. In this manner, even in a case where only one type of sensor is actually available, as illustrated in FIG. 9, the number of targets is observed from different viewpoints, and each of the number of targets is handled as the number of observations of different sensor types as if there are a plurality of sensor types, and the estimation accuracy of the number of targets is improved by mathematical optimization.

FIG. 9 illustrates an example in which mathematical optimization processing is applied on the number of people present derived for each of first areas (A′1˜) using a sensor type A from a first viewpoint (sensor type A′), the number of people present derived for each of second areas (A″1˜) using the sensor type A from a second viewpoint (sensor type A″), and the number of people present derived for each of third areas (A′″1˜) using the sensor type A from a third viewpoint (sensor type A′″) to estimate the number of people present in each of fourth areas.

As described in each of the above methods, the observation range at time of the input to the mathematical optimization processing is not the same definition between different methods. In addition, the observation range of any one of the methods input to the mathematical optimization processing and each area representing the number of people present at the output from the mathematical optimization processing are not necessarily the same.

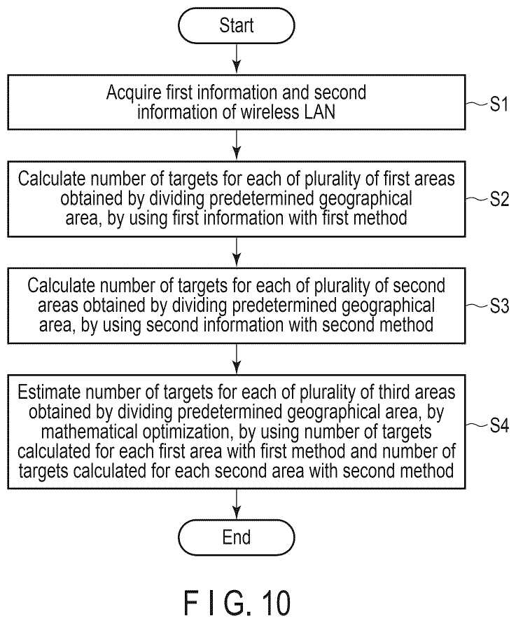

FIG. 10 is a flowchart illustrating a processing procedure of the target number estimation device 4 according to the embodiment.

The target number estimation device 4 acquires first information and second information of the wireless LAN (S1).

The target number estimation device 4 calculates the number of targets for each of a plurality of first areas obtained by dividing a predetermined geographical area by using the first information with the first method (S2).

The target number estimation device 4 calculates the number of targets for each of a plurality of second areas obtained by dividing the predetermined geographical area by using the second information with the second method (S3). Step S2 and step S3 may be processed in parallel.

The target number estimation device 4 estimates the number of targets for each of a plurality of third areas obtained by dividing the predetermined geographical area by mathematical optimization, by using the number of targets calculated for each of the first areas with the first method and the number of targets calculated for each of the second areas with the second method (S4).

As described above, the target number estimation device 4 in the embodiment can derive the number of observation targets from different viewpoints as if there are a plurality of sensor types while there is only a single sensor type, and obtain the number of targets in a target area by mathematical optimization.

That is, the target number estimation device 4 according to the embodiment can improve the target number estimation accuracy by mathematical optimization for a single sensor type.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A target number estimation device comprising:
a data acquisition unit configured to acquire a first signal and a second signal, the first signal including information regarding a set of a first area obtained by dividing a predetermined geographical area and the number of targets corresponding to the first area, by the number of first areas, the second signal including information regarding a set of a second area obtained by dividing the predetermined geographical area and the number of targets corresponding to the second area, by the number of the second areas; and
a target number estimation unit configured to apply mathematical optimization processing on the number of targets for each of the first areas included in the first signal and the number of targets for each of the second areas included in the second signal to generate a third signal including information regarding a set of a third area obtained by dividing the predetermined geographical area and the number of targets corresponding to the third area, by the number of the third areas, wherein
both the first signal and the second signal are signals generated based on a same first wireless system,
the first signal is based on first information of the first wireless system, and
the second signal is based on second information of the first wireless system.

2. The target number estimation device of claim 1, wherein
one of the first area and the second area is an observation range of a master station defined in advance in the master station of the first wireless system that forms a wireless service area in the predetermined geographical area, and
the number of targets corresponding to one of the first area and the second area is the number of slave stations that exist in the observation range of the master station and are connected to the master station.

3. The target number estimation device of claim 2, wherein
the number of targets corresponding to one of the first area and the second area is a slave station in which a first value of a wireless signal received by the master station is equal to or more than a threshold value among the slave stations connected to the master station.

4. The target number estimation device of claim 2, wherein
the number of targets corresponding to one of the first area and the second area is a slave station in which a first value of a wireless signal received by the master station is less than a threshold value among the slave stations connected to the master station.

5. The target number estimation device of claim 3, wherein
the first value is a received signal strength indicator (RSSI) or a signal-to-noise ratio (SNR).

6. The target number estimation device of claim 1, wherein
one of the first area and the second area is an observation range of a master station defined in advance in the master station of the first wireless system that forms a wireless service area in the predetermined geographical area, and
the number of targets corresponding to one of the first area and the second area is the number of slave stations that exist in the observation range of the master station and are observed by the master station regardless of whether or not the master station is connected.

7. The target number estimation device of claim 6, wherein
the master station is configured to receive a wireless signal having a predetermined frequency, and observe the slave station existing in the observation range of the master station based on the wireless signal.

8. The target number estimation device of claim 7, wherein
in a case where the same slave station is observed by two or more master stations among a plurality of the master stations, the slave stations are counted as a corresponding number associated with a master station in which a second value of a wireless signal received from the slave station is largest among the two or more master stations.

9. The target number estimation device of claim 8, wherein
the second value is an RSSI.

10. The target number estimation device of claim 1, wherein
one of the first area and the second area is a section obtained by dividing the predetermined geographical area in units of blocks having a predetermined size, and
the number of targets corresponding to one of the first area and the second area is the number of the slave stations counted for each section by
estimating respective distances between a plurality of master stations and the same slave station based on signals respectively received from the same slave station by the master stations that form a wireless service area in the predetermined geographical area,
estimating a position of the slave station based on the respective distances between the master stations and the slave station, and
specifying a section including an estimated position of the slave station.

11. The target number estimation device of claim 10, wherein
the position of the slave station is estimated by trilateration using respective distances between three master stations among the master stations and the slave station.

12. The target number estimation device of claim 2, wherein
the first wireless system is a wireless local area network (LAN),
the master station is an access point of the wireless LAN, and
the slave station is a station of the wireless LAN.

13. A method of estimating a target number in a predetermined geographical area, the method comprising:
acquiring a first signal and a second signal, the first signal including information regarding a set of a first area obtained by dividing the predetermined geographical area and the number of targets corresponding to the first area, by the number of first areas, the second signal including information regarding a set of a second area obtained by dividing the predetermined geographical area and the number of targets corresponding to the second area, by the number of the second areas; and
applying mathematical optimization processing on the number of targets for each of the first areas included in the first signal and the number of targets for each of the second areas included in the second signal to generate a third signal including information regarding a set of a third area obtained by dividing the predetermined geographical area and the number of targets corresponding to the third area, by the number of the third areas, wherein
both the first signal and the second signal are signals generated based on a same first wireless system,
the first signal is based on first information of the first wireless system, and
the second signal is based on second information of the first wireless system.

14. A non-transitory computer-readable storage medium having stored thereon a computer program which is executable by a computer, the computer program controlling the computer to execute functions of:
acquiring a first signal and a second signal, the first signal including information regarding a set of a first area obtained by dividing a predetermined geographical area and the number of targets corresponding to the first area, by the number of first areas, and the second signal including information regarding a set of a second area obtained by dividing the predetermined geographical area and the number of targets corresponding to the second area, by the number of the second areas; and
applying mathematical optimization processing on the number of targets for each of the first areas included in the first signal and the number of targets for each of the second areas included in the second signal to generate a third signal including information regarding a set of a third area obtained by dividing the predetermined geographical area and the number of targets corresponding to the third area, by the number of the third areas, wherein
both the first signal and the second signal are signals generated based on a same first wireless system,
the first signal is based on first information of the first wireless system, and
the second signal is based on second information of the first wireless system.
